(19) United States
(12) Patent Application Publication
(10) Pub. No.: US 2004/0086832 A1
(43) Pub. Date: May 6, 2004

(54) System for biomechanical endodontic preparation

(76) Inventor: Henrique Artur Azevedo Bassi, Belo Horizonte (BR)

Correspondence Address: Clark & Brody, Suite 600, 1750 K Street N W, Washington, DC, 20006, US

(21) Appl. No.: 10/432,950

(22) PCT Filed: Nov. 29, 2001
(86) PCT No.: PCT/BR01/00149

(30) Foreign Application Priority Data
Nov. 30, 2000 (BR) PI 0006453-0

(51) Int. Cl. A61C 5/02

(52) U.S. Cl. 433/224; 433/102

(57) ABSTRACT

The present system for biomechanical endodontic preparation uses an electro-electronic piece of equipment commanded by software, based on the principle whereby the mechanical forces determining the fracture of the file are monitored by an electronic circuit of great precision to detect the existence of a force equal to or greater than the one determined by the system, and interrupt its operation prior to the actual risk of file fracture, developed to monitor the forces applied to the file being used, within the sequence of sectored cutting, as appropriate for the work, controlling the torque applied to said files, thus avoiding their rupture.

This patent refers to a new system for biomechanical endodontic preparation, developed on the basis of the principles described in the patent entitled “ROTARY ENDODONTIC FILE”, PI 9801256, filed on 14 Apr. 1998.

In order to allow a proper understanding of the problems involved in the technique currently used, a brief description of its evolution will be provided.

Endodontics have been around for several centuries, but it is only in the last 30 years that significant technical advances have been made in this field, applying new materials which have increased the success rate of the treatment.

Basically, the main instrument used in endodontic treatment is the endodontic file, which is the same instrument, which has been used for the past 70 years, as well as certain chemical products.

One of the main problems related to the endodontic file is that fact that this instrument is subject to breakage or fracture inside the root canals. This type of accident is highly undesirable, for it can seriously hinder the correct preparation of the canals or even impede their correct disinfection.

Thus, biomechanical preparation is unquestionably one of the most important phases of endodontic treatment, in addition to being the phase, which is most demanding of the professional involved. The main goals of biomechanical treatment are the cleaning, disinfection and modeling of the root canals, in order to allow this cavity to receive proper filling of the entire root canal system. Therefore this is the most stressful and time-consuming phase of the treatment.

One of the most widely accepted concepts, introduced by Schilder, is the configuration of a progressive conical preparation of the entrance of the canal to the terminal portion at the level of the apical foramen.

It is a proven fact that in the preparation of curved canals failures can occur, such as perforations, apical transportation, formation of steps, zips, and break of the instrument. With the objective of minimizing mistakes and increasing both the efficiency and the quality of the preparations, changes have been suggested in the types of metal alloys of the endodontic files and the instrumentation methods.

One of the first researchers to propose a Ni—Ti alloy as a material for the production of endodontic instruments was CIVJAN. Subsequently, Walia et al., in 1998, performed a comparative study between the Ni—Ti files and the stainless steel files.

Due to the physical/mechanical qualities (elastic memory, low elasticity module) of the new Ni—Ti alloy, rotary mechanical instrumentation was proposed with these instruments. The main objective was to obtain high quality instrumentation in the root canals, maintaining the original position and also maintaining the patency of the apical foramen. Another objective was to reduce the required work time.

In 1976, the International Standards Organization (ISO) approved specification n^{o} 28 of “ADA” for K-type dilators and files. An international standardization occurred in the design of the instruments, leading to the development of a formula for the diameter and conicity of each size of instrument.

Accordingly, the diameter of the instrument is measured in fractions of a millimeter. This measure is taken from a point, which is located 1 mm from the point of its blade, called D1. The cutting or active part of the blade goes from the initial point D0 to a point 16 mm away - D16. The increment at each mm which varies between D0 and D16 is 0.02 mm. Therefore, in a series of instruments, the increase in diameter at its tip compared to the next one, when measured at D0, is 0.02 (# 06, # 08, # 10); 0.05 (# 10, # 15, # 20 . . . # 60) and 0.1 (# 60 . . . # 140).

Thus, for many years, all root canal instrumentation used a series of standardized instruments with a single conicity or taper, varying solely in the dimensions of the tips.

TABLE 1
Diameter of the standardized endodontic
instruments (ISO), pursuant to the
specification No. 28 of GEVISA.

Diameter of instument

| No. of instrument | D0 (mm) | D16 (mm) |
|---|---|---|
| 10 | 0.10 | 0.42 |
| 15 | 0.15 | 0.47 |
| 20 | 0.20 | 0.52 |
| 25 | 0.25 | 0.57 |
| 30 | 0.30 | 0.62 |
| 35 | 0.35 | 0.67 |
| 40 | 0.40 | 0.72 |
| 45 | 0.45 | 0.77 |
| 50 | 0.50 | 0.82 |
| 55 | 0.55 | 0.87 |
| 60 | 0.60 | 0.92 |
| 70 | 0.70 | 1.02 |
| 80 | 0.80 | 1.12 |
| 90 | 0.90 | 1.22 |
| 100 | 1.00 | 1.32 |
| 110 | 1.10 | 1.42 |
| 120 | 1.20 | 1.52 |
| 130 | 1.30 | 1.62 |
| 140 | 1.40 | 1.72 |
| 150 | 1.50 | 1.82 |

Due to the tremendous facility that mechanical instrumentation offered dentists, the use of motor-driven files became increasingly popular in endodontic treatment. However, the mechanical instrumentation presents a high risk of file fracture.

As pointed out above, the instruments which break or fracture inside the canals obstruct the passage of higher caliber instruments and also hinder the passage of irrigating agents, impeding the cleaning of the root canals and are almost always detrimental to the treatment, often requiring subsequent small surgical interventions.

In view of this type of problem found in all currently known techniques, a new system has been developed, which controls a piece of equipment, with the basic objective of providing greater safety and speed in endodontic treatment. This involves the use of a series of specific files for each region to be treated, the basic principles of which are described in the patent entitled “ROTARY ENDODONTIC FILE”, PI 9801256, filed on 14 Apr. 1998.

This patent proposes a new objective: to change the POINT OF FRACTURE OF THE ENDODONTIC FILES, from inside the canals, to an upper portion of the instrument (inactive portion) located outside the canals.

This region of the instrument would consequently be more susceptible to fracture; however, as solely this region of the instrument is under tension, it is possible to determine the maximum capacity, or maximum tension limit, for the moment of fracture.

As the tension would be dissipated throughout the entire instrument, upon creating a weakened area in the inactive part, outside the canal, which would bear a smaller tension than the tensions found in the areas inside the canal, the point of fracture would be shifted to this weakened area.

This would allow the avoidance of any complications arising from the fracture of an endodontic file during its use.

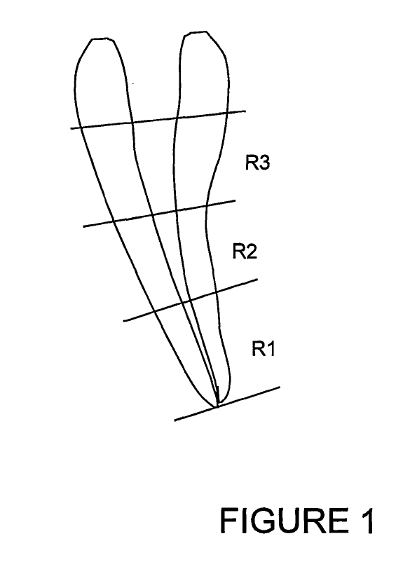

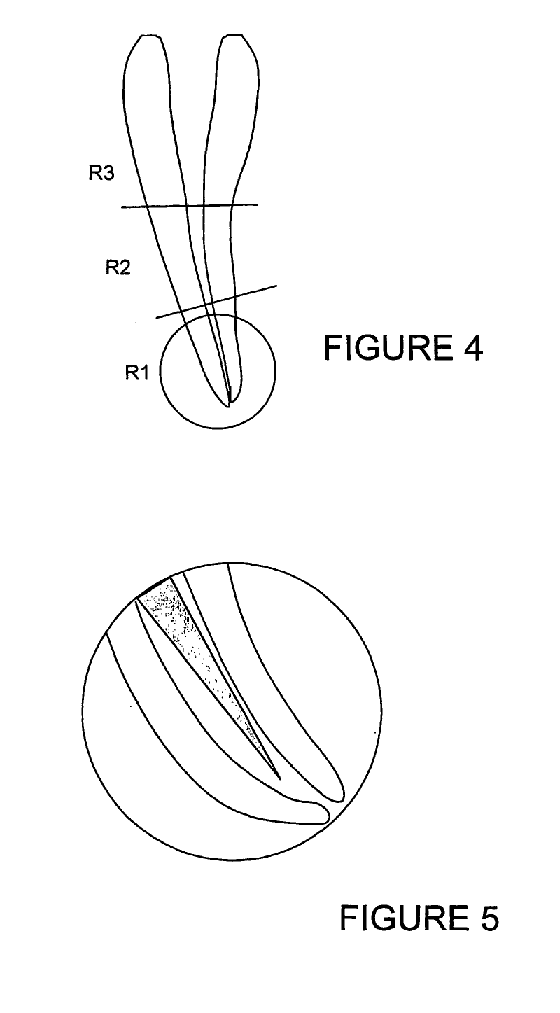

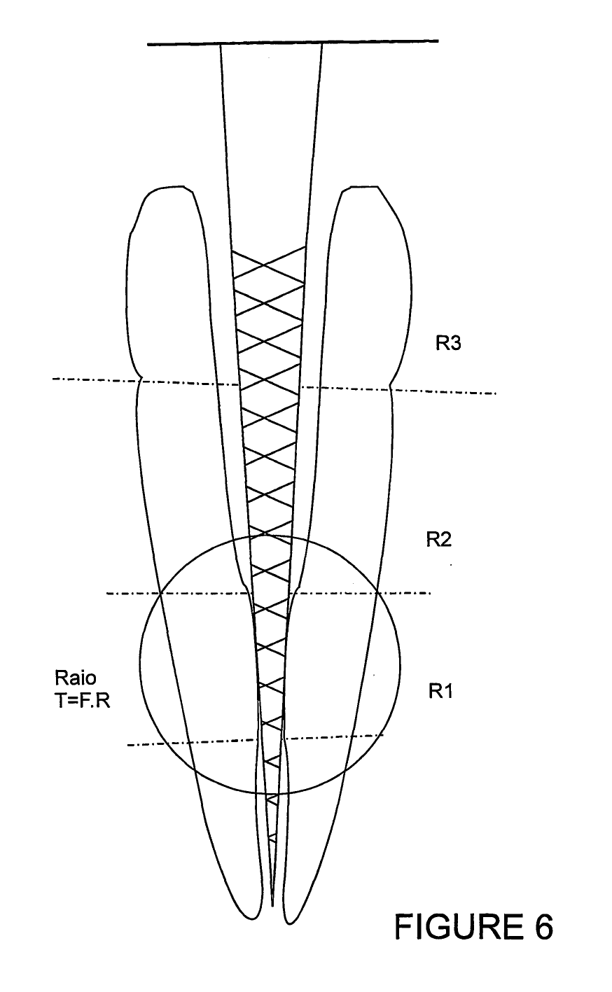

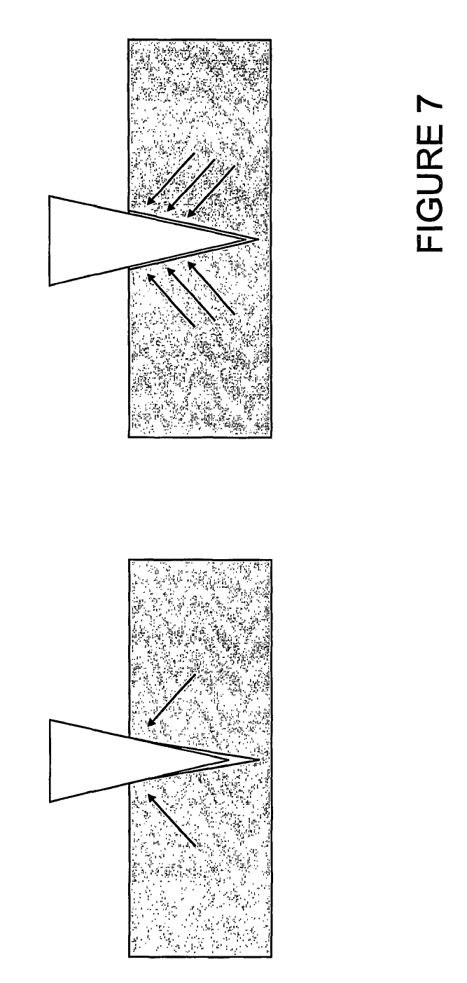

This patent is based on the concept described above, i.e., that the point of fracture would not be reached. This goal can be achieved through the use of a unique sequence of formats (tapers) of files, so that the stress of the instrument would be concentrated in small portions of the file during the dental work. See FIGS. 1 to 6.

The main problem inherent to the current systems of rotary instruments refers to the lack of safety presented by all systems. Thus, during the mechanical cutting work, the file undergoes forces which are difficult for the operator to control. Until now, all efforts to establish a standard or protocol for use have not been sufficient to prevent the breaks or fractures of files inside root canals. The fractures presented by the mechanical instrumentation systems for root canals are basically caused by an overload of the instrument or stress. One can thus say that the fractures of the endodontic files occur due to two basic types of stress, namely:

Stress by a twisting force

Stress by cyclic fatigue

Stress by cyclic fatigue is related to the metal mass which composes the file. Even though the Ni—Ti alloy is extremely resistant to cyclical fatigue, the files also have a maximum limit of resistance. It is a known fact that, the larger the metal mass, the more quickly the metal presents cyclical fatigue.

Torsion stress occurs due to the friction between the file and the canal wall resulting from the cutting work. This effort generates forces in the surface of the file, which are controlled solely by the skill of the operator. This leads to a problem, for the degree of skill varies considerably, and even the most skillful and well-trained clinical professional finds it difficult to control this excessive force to which the instrument is submitted.

Current systems also present inefficient mechanics due to the large area of contact between the surface of the file and the surface of the canal.

This mechanical inefficiency leads to a greater demand of energy. The way to make up for this inefficiency is to apply more torque to the instruments, which of course increases still further the risk of fracture.

The first to suggest a change in order to increase mechanical yield of endodontic instruments was McSpadden. He suggested that a variety of files be used in sequence in order to restrict this friction surface between the files and the walls of the canals.

The increased mechanical efficiency of the instruments resulted from the sectored cut with the limitation of the contact between the files and the walls of the canals. Thus, the energy generated for the instrument was not dissipated along the entire surface of the file and stayed concentrated in certain points, always as high as possible, reducing the stress of the files.

In varying the tapers of the files in a single sequence, McSpadden's objective was to maximize the mechanical efficiency of the files, minimizing the mechanical stress of the instruments.

Although this represented a major evolution in terms of cutting efficiency, in fact the problem pointed out as the cause of the loss of mechanical yield, i.e., the large friction area between the file and the wall of the canal—still remained with the new proposal of McSpadden, as shown in the table below. As a matter of fact, when one observes the cutting work in the proposed sequence, one can see that there is still torque along the full surface of the instrument.

TABLE 2
Diameter of endodontic instruments,
Multi-Taper, used by McSpadden.

| | Diameter of instrument | | |
|---|---|---|---|
| No. of instrument | D0 (mm) | Taper | D16 (mm) |
| 15 | 0.15 | 02 | 0.47 |
| 20 | 0.20 | 02 | 0.52 |
| 25 | 0.25 | 02 | 0.57 |
| 25 | 0.25 | 03 | 0.73 |
| 25 | 0.25 | 04 | 0.89 |
| 25 | 0.25 | 05 | 1.05 |
| 25 | 0.25 | 06 | 1.21 |

Although McSpadden's multi-taper system showed good results, in the cases of canals with a small curvature radius and roots with a large curvature angle, failures appeared. As shown by Pruett & al (10) during work with curved canals, the Ni—Ti files are subject to cyclic fatigue during work. Cyclic fatigue can lead to unexpected fractures, mainly when one uses files with larger tapers (greater metal mass).

In 1996, Bassi, observing the high number of fractures in instruments among users of the rotary mechanical system, suggested a modification, which he called the Segmented Preparation Technique. The objectives of the new proposal made by Bassi were:

1—Obtain a sequence of files capable of instrumenting the root canals within the modern standards of endodontics, however with more flexible instruments in the portion of greater fracture risk so that the files would undergo less stress due to cyclic fatigue.

2—Obtain a sequence of files capable of really performing the cutting work by well-delimited parts and small areas, through alternating the instruments “Quantec”® and “Tulsa”®.

3—Obtain a passive guide point to facilitate access of the endodontic instruments to the more curved canals.

4—Obtain a sequence with the smallest possible number of files.

Bassi observed that most of the fractures in files occurred during the preparation of the third phase of the multi-taper technique proposed by McSpadden.

Another fact observed was related to the region where the fractures occurred. Frequently fractures occurred between 3 and 6 mm from the D0 point of the instrument. This fracture region was called by Bassi the danger zone. Among the most commonly fractured instruments were the files of a larger taper, 05 and 06.

It was easy to see that when the taper of the instruments was increased, to obtain the desired conicity (conic progressive), the instruments became quite rigid, mainly in the apical portion. Thus, the more rigid the instrument, working in curved canals, the greater were the chances of fracture.

Upon analyzing the Quantec sequence proposed by McSpadden, Bassi observed that the basic philosophy of the technique, to concentrate small areas of contact between the file and the wall of the canal, was frustrated.

We observed that when all the files reach the working length, there is also contact along the entire surface of the canal wall. This means that most of the body of the file is under stress and consequently the efficiency of the instrument, as well as its safety, will be compromised, for there will be a large consumption of energy, which is not desirable.

In order to solve the problem of cutting along a large extension, instrumentation was proposed in three quite distinct phases:

1. Cervical Phase

2. Apical Phase

3. Intermediate Phase* It was seen that most of the fractures occurred in this phase.

In order to allow an understanding of the principles adopted for the creation of the currently proposed system, they will be described in detail, taking also advantage of several studies which have already been performed and which allowed the evolution of the comprehension of the physical forces involved in this type of work.

In order to provide flexibility to the files in the danger zone, and consequently reduce the metal mass in this region, without losing the benefit of the larger tapers, Bassi conceived prototype files for the intermediate phase, where most fractures occurred.

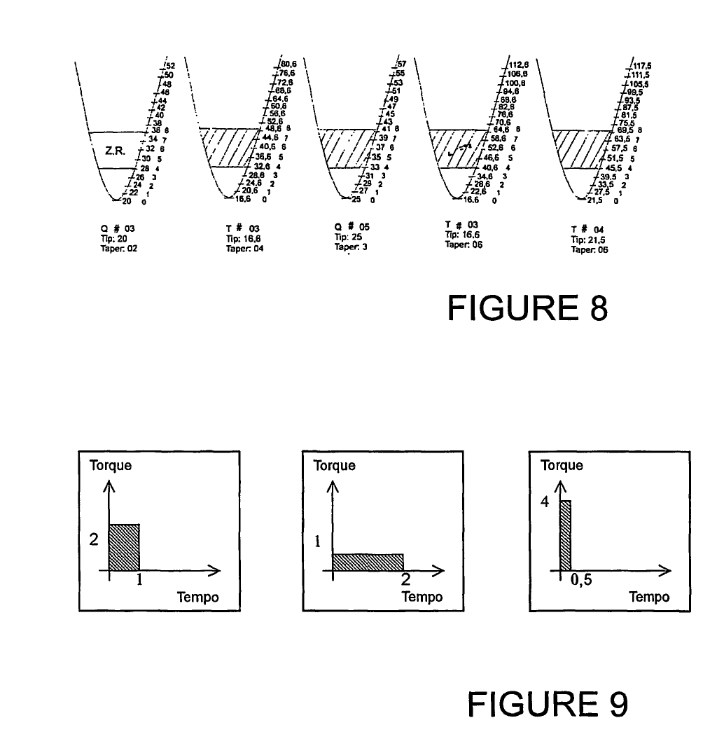

These prototype files have a smaller D0 point than the last file used in the apical preparation, and a larger taper than the largest taper used in the apical preparation file. See FIG. 8.

Thus, during the preparation of the intermediate portion or the modeling of the canal, the apical part of the file is always free (passive), only touching the walls in an area of 2 to 3 mm. With the Sectored cut, it is possible to minimize the use of energy.

The big advantage of using files with points of small diameter during the preparation of the Intermediate Phase is the great flexibility that these instruments acquire, avoiding cyclic fatigue.

On today's marketplace there is a veritable arsenal of rotary Ni—Ti files (Quantec, Tulsa, Malleifer, etc.), each of which has its sequence determined by the manufacturer. But doubts still persist as to a truly safe and efficient technique from the mechanical standpoint.

The most efficient file sequence will be the one which performs the same work of opening and widening the canal, using the smallest quantity of energy to flex the instrument. We could say that the most efficient sequence is the one which performs the Cutting Work using the least energy to flex the file. Thus, when we compare the efficiency of the available techniques, we are talking about mechanical yield.

In order to understand this statement, we would have to look at Physics. Energy represents “the capability of performing work”. When the work is exerted upon a body, a certain quantity of energy is supplied to the latter.

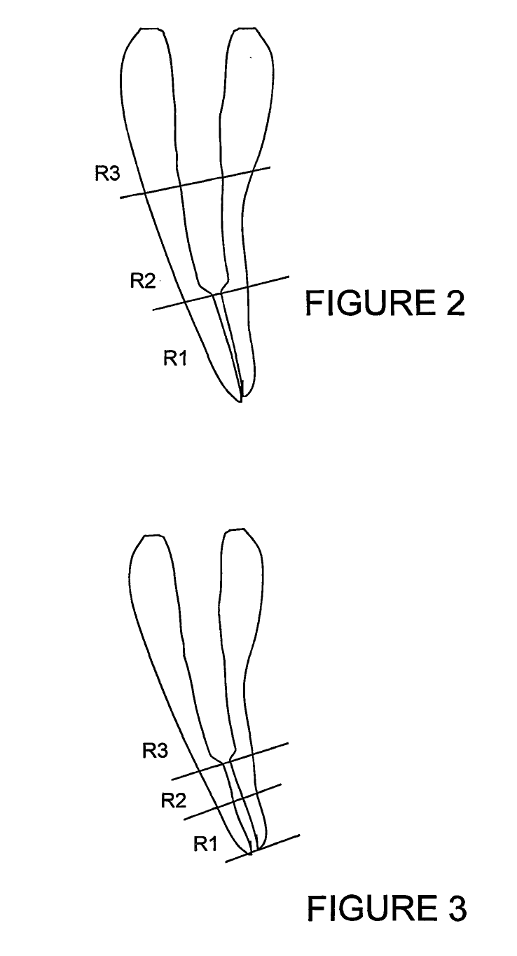

In FIG. 2, considering that force F is constant, we have three different torque values as a function of the radius, therefore we have R1<R2<R3 e T1=1 N/n, T₃=3 N/n.

In order to understand better yet, we can exemplify the concept of energy illustrated through three charts in FIG. 9.

In all the charts, the energy expended is the same, in spite of the variations in torque and time.

We can state, based on the charts, that the professional performed the canal work in different time periods, and in the third chart, as the torque was greater, he got closer to the avalanche phenomenon, thus increasing the risk of fracture.

When we speak of rotary systems, we refer to a type of mechanical energy. This energy can be defined through the following equation:

E=torque (N/m)×time (s)×rotation speed (expressed in Joules)

Torque is the rotary work performed by the file, and this varies as a function of the force and the radius (Torque=F×R). We should point out act that, as the endodontic files are conical instruments, along their surface there are different force values for each radius, as seen in FIG. 1.

Therefore, in a single “conical” instrument, there are different torques occurring at the same time along the surface of the file.

When we are preparing a canal, and during this process the file is in contact with a large surface, we do not know to which portion of the file we should apply the proper torque. This is one of the great advantages of the Sectored cut. We will always have control of the portion where the instrument works.

Another major advantage of using the sectored torque is directly related to the reduced need for energy. Thus, during the mechanical work, we will use energy levels much lower than in other techniques. We know that, with use, micro-fractures occur on the surface of the rotary instrument. When we use a high torque limit over a longer period of time, these micro-fractures may cause the fracture of the rotary instruments.

To finalize, the design and the diameter of the cross section of the file and the curvature of the canals will have a direct influence on the energy required to flex the instrument.

As to the cross section of the instrument, we should observe that, the larger the metal mass, the greater need there will be for energy to flex it, rendering it more susceptible to cyclic fatigue.

With regard to the curvature of the canals, the greater the curvature angle of the root, or the smaller the radius of the canal curvature, the greater will also be the consumption of energy to flex the instruments.

As we said, the diameter of the Ni—Ti file and the curvature of the canals are inseparable factors in the file sequence used to model the root canals.

The sequences available on the market, most of the time, do not respect these factors. They do not seek a balance between the increase in diameter of the instrument and its flexibility, offering instruments with greater diameters, used in the search of the proper flare, however lacking flexibility.

Several alternatives have appeared with the objective of trying to minimize the risk of file fracture, expanding the use of rotary instruments. Power-driven devices are appearing on the market.

However, even with all these adaptations, fractures still occur, without any prior visible permanent deformation to indicate that the elastic limit of the metal had been surpassed, resulting in the avalanche phenomenon.

The avalanche phenomenon is a mechanical situation which involves the locking of the point of the rotary instrument, thus resulting in a very high torque, leading to the fracture of the instrument.

In a normal situation, the instrument twists, turns and generates a torque according to the depth, in other words, the energy is spent to open the canal.

However, when the point locks, the instruments tends to twist more than desired, and the energy is spent to twist the file.

After explaining the principles on which the present system was developed, a software application was developed, which receives the information on torque applied and controls it by means of equipment with a microprocessor (hardware).

The patent outlined herein presents a new system for biomechanical endodontic preparation, using electro-electronic equipment commanded by software, based on the principle that the mechanical forces determining the fracture of the file will be monitored by an electronic circuit of high precision, to detect the existence of a force equal to or greater than the one determined by the system, and interrupt its operation prior to the actual risk of file fracture.

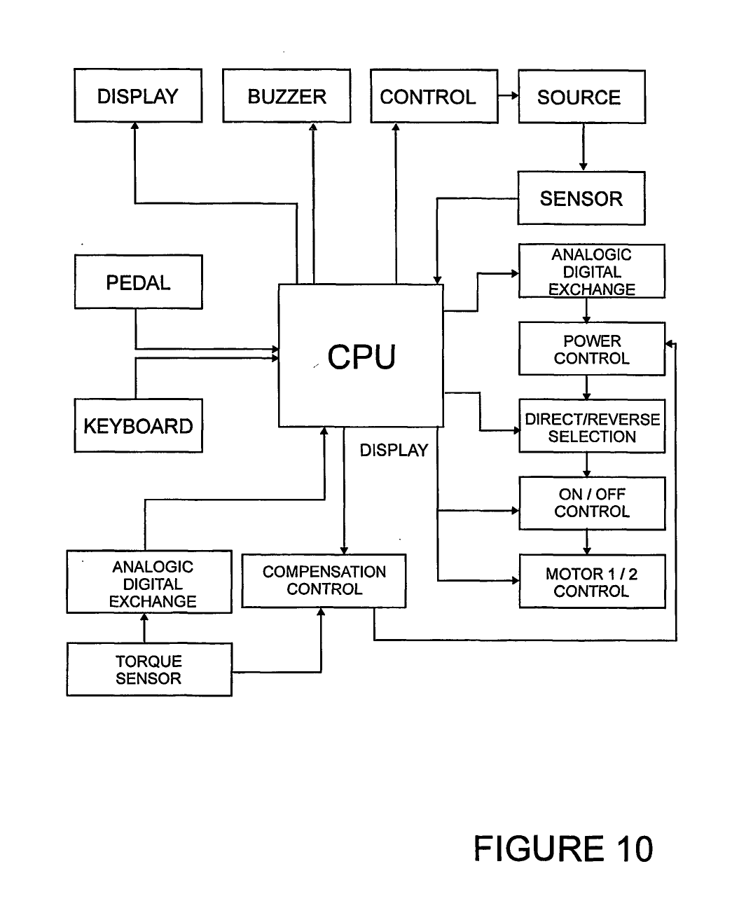

The block diagram shown in FIG. 10 illustrates its components and respective functions.

The present system for biomechanical endodontic preparation is based on the principles outlined above and uses a software application developed to monitor the forces applied to the file in use, within the sequence of sectored cutting, as required for the work.

This monitoring allows the equipment (hardware) to control the torque applied to the files, preventing their rupture.

In the aforementioned patent—Rotary Endodontic File, PI 9801256, the principle used was the transfer of the rupture/fracture point, greater fatigue, to the external part of the file, thus preventing it from breaking inside the canal.

In this patent, the fracture point (mechanical moment) no longer exists, for the software coupled to the hardware, upon detecting excessive torque, in addition to interrupting the work, also suggests, through the display, the replacement of the file in use by another in that sequence obtained through the above-mentioned study.

Both patents require the establishment of a sequence of files, which, in addition to mechanically increasing the power of the instruments, provide a direct relation/ratio between the torque values and the file working area.

The advantages obtained by the use of this system are multiple, and among the main ones, one can mention: the possibility of performing endodontic work in an extremely short time, something heretofore not possible, with millimetric precision and tremendous reliability.

Using the system hereunder, one eliminates the greatest inconvenience of endodontic work, which is the risk of fracturing the files due to excessive torque, now preventable by the scientific control of the diameters of the files, and the most important principle is that the diameter of the subsequent taper and the torque force are proportional.

This is possible because each file works in a pre-defined area. Thus, as one knows the radius of the contact region, one can define the required torque limit for the cut to reach the necessary radius.

In FIG. 8 one can see part of the sequence of the new proposal for instrumentation of canals class I, II and III.

One can see that there is a significant reduction in the quantity of metal, i.e., of the diameter of the cross section of the instrument in the risk or danger zone. One can see that the flare is not impaired (Bassi Sequence).

If by any chance the operator insists on making the file cut more than it should, its cutting radius will increase, as well as the contact area, thus requiring an increase in torque. As the information provided by the software is exact in numeric values, the system turns it off, not allowing the file to proceed with the cutting work.

From the moment in which it was possible to obtain control of the torque and the limit of each file, there was a change in the form of defining the torque, making the whole system take another direction.

The difference between using torque control with a Crown Down sequence or a Quantec sequence is directly related to the performance of the technique. For example, if we are using a Crown Down sequence, the tip of the file will always be the first part of the instrument to touch the canal walls.

In order to have an effective control of the torque, we must project the maximum torque limit to this portion. Thus, when we are working with a sequence which works mainly with the tip of the file, the torque limit to be applied will be quite low, an consequently will determine a technique with low performance or low mechanical yield.

When we use a preparation of the segmented type, due to the various portions of work, point, intermediate cervical, etc., the torque values applied are exact for the portion performing the work, and thus one uses the OPTIMUM TORQUE, determining a more efficient sequence from the mechanical standpoint (mechanical yield).

All of this benefit of controlling the depth and torque is related to the sequence of files advocated by the segmented preparation technique.

Thus, we opted to limit the torque to what is necessary for the file to reach the required canal depth point.

The torque control was used not only to protect the file, but also to have it cut only as much as required for the conicity of the canal to be almost perfect.

Therefore, upon using an initial file, called the pre-widening one, one defines the depth limit, and the other files automatically cut only as much as needed within this pre-established limit, and each file cuts only as much as needed to obtain the desired canal conicity.

Another innovative factor is that the files only undergo the stress required for the cutting, i.e., after performing the work strictly required for the opening, the device does not allow the file to continue working. This considerably increases the useful life of the files, resulting in reduced material costs.

More important still is to define that each file performs a sectored cut, based on the fact that the previous file did its job, and the point of the file in question will not touch the canal. This is extremely important, for the electronic equipment takes this into account, and if a given file touches a region with a smaller radius, outside its working area, the equipment will allow a greater torque than the region actually bears.

Thus, a given file has a cutting limit for a gien region, and it is necessary that the previous file will also have worked its respective region properly.

One can see that the same file can work in different regions, for it is up to the operator to determine a selection of files and their work method. But in this case, the same file will have a different torque limit for each work region.

One should point out that if the file cuts only what it should, the operator no longer has to work with such caution, with a very low torque, fearing the possible fracture of the file. Therefore he can apply maximum torque to the file, for the sound control system of the equipment allows him to monitor the pressure on the instrument in an optimized manner.

Knowing that Energy=Torque×Time×Velocity, the operator can achieve maximum file torque and reduce his working time. This theoretically would allow the operator to perform the canal cut in much less time.

With regard to mechanical efficiency, in all experiments the most efficient was that of Dr. Bassi, for it allowed a satisfactory progressive conic preparation expending less energy.

Another observation made was the sequence of files (diameter and tips) employed for the execution of a mechanical task (shaping the canal) which has a direct influence on the total consumption of energy of the files. With the use of the system proposed by this patent, it is possible to obtain a reduction of up to 50% of the energy expended between one sequence and another.

As a conclusion of our studies and experiments, we can affirm that the sequence of Dr. Bassi presents a smaller total energy outlay per tooth, and also offers a progressive conic formatting suited to the canal.

Thus one can definitively demonstrate that a well planned file sequence will result in greater efficiency, and that a torque control with limits established individual for each sequence will multiply the performance of the same sequence, with maximum use of the instrument, reduction in work time, and with the result of a theoretically perfect conicity.

In order to achieve a perfect understanding of the operation of the electro-electronic equipment proposed hereunder, its block diagram is described below.

### Source

Has the function of feeding the entire electronic system with the necessary tensions.

### Control

Receives a signal from the CPU to connect or disconnect the source. Not a fundamental part of the system.

### Sensor

Checks if the source is functioning and informs the CPU. Also not fundamental part of system.

### Torque Sensor

Transforms the torque applied to the motor shaft in proportionate tension.

### Analog/Digital Converter

Converts the signal generated by the Torque Sensor into a digital signal so that the CPU can use it in its conversion calculations.

### Compensation Control

Monitors the torque applied to the motor and generates a preparation compensation tension to make up for the drop in rotation. This system can be external or internal to the CPU; if internal, it performs the same functions with the same results.

### Digital Analog Converter

Transforms the digital signal supplied by the CPU into a proportionate tension to control the rotation of the motor. If the compensation control is inside the CPU, the proportionate tension to maintain the rotation of the motor will also use this block, or another equivalent block for dedicated use.

Allows the motor control tension to command the motor, using a power buffer to dissipate the required power.

### Direct Reverse Selection

Receives a command from the CPU to make the motor turn counterclockwise, or clockwise.

### On/Off Control

Receives a command from the CPU to turn the motor on or off.

### Motor Control 1 or 2

Selects motor number 1 or 2, according to the CPU command

### Buzzer

Generates a sound signal, of any frequency or amplitude, to indicate some CPU process to the operator.

### Display

Indicates to the operator the processes which occur in the CPU, both in terms of operation and system configuration.

### Keyboard and Pedal

Supplies the CPU with the commands given by the operator to the system.

### CPU

Central Processing Unit, responsible for receiving all signals and commands, and acting on all the output devices.

Start of operation—the CPU connects the entire system and seeks the configuration information used the last time. Adjust working velocity, connects the motors, and analyzes the torque values without any load for subsequent calculations. It then loads all the data related to the sequence to be used, and the torques that each file of the sequence will use.

General Operation. The CPU monitors the keyboard and the pedal to execute operator commands. Through the pedal, the operator can select working sequence, motor system (single or double), a specific sequence, change sequence, place the motor in reverse mode and rotation, adjust working speed, etc.

Through the pedal, the operator turns the motors off and on, and shifts to the next working file in the selected sequence.

The CPU monitors the motor operation torque and generates an audible signal, which informs him that he is nearing the maximum working torque for the file in use. When the torque is exceeded, the CPU turns off the motor, places the motor in reverse mode so that the operator can remove the file, and returns it to normal mode to continue the process.

The CPU checks if the device is idle; if it is, it disconnects it automatically. This function is not essential to the system.

The CPU controls the speed of the motor through the analog/digital converter, and if the compensation is internal, it calculates the value required for the output to maintain the motor at a constant speed.

Turns the motor off or on according to the pedal command.

Selects motor 1 or 2, pursuant to the file change within the sequence. This is used to expedite the operator's work, for while he is working with one motor, the other one is being prepared by his assistant for the next phase.

Writes on the display all of the information required by the operator to operate and configure the system, as well as warning and help information.

1. BIOMECHANICAL ENDODONTIC PREPARATION SYSTEM, developed on the basis of the principles described in the patent entitled “ROTARY ENDODONTIC FILE”, PI 9801256, filed on 14 Apr. 1998, which is a new system for equipment control, with the basic objective of offering greater safety and speed in endodontic treatment. It involves the use of a series of specific files for each region to be treated, seeking to obtain a sequence of files capable of instrumenting root canals pursuant to modern endodontic standards, however with instruments which are more flexible in the region of greater fracture risk, so that the files undergo less stress due to cyclic fatigue, characterized as a sequence of files capable of performing cutting work by well defined sections and small areas, by alternating between the instruments “Quantec”® and “Tulsa”®; obtain a passive guide point to facilitate the access of the endodontic instruments to the more curved canals and also obtain a sequence with the smallest possible number of files, with instrumentation in three quite distinct phases: cervical, apical and intermediate. This will provide flexibility to the files in the danger zone, thus reducing the metal mass in this region, without losing the benefit of the larger tapers. This systems for biomechanical endodontic preparation uses an electro-electronic equipment commanded by software, which is based on the principle that the mechanical forces determining the file fracture will be monitored by an electronic circuit of high precision, to detect the existence of a force equal to or greater than that determined by the system, and interrupt its operation before the actual risk of fracturing the file, developed to monitor the forces applied to the file in use, within the sequence of sectored cutting, as appropriate for the work, controlling the torque applied to said files, avoiding their rupture and also doesn't cut more than the programmed area in that sector, being the diameter of the subsequent taper and the torque force proportional.

2. BIOMECHANICAL ENDODONTIC PREPARATION SYSTEM, pursuant to appeal 1, where the advantage of using files with a small diameter tip during the preparation of the intermediate phase is the great flexibility that these instruments acquire, avoiding cyclic fatigue, characterized by using in the intermediate phase, modeling of the canal, files which have a D0 point smaller than the last file used in the apical preparation and a larger taper than the one used in the file of the apical preparation, touching against the walls in an area of 2 to 3 mm, with the apical part of the file always free (passive).

3. BIOMECHANICAL ENDODONTIC PREPARATION SYSTEM, pursuant to the appeals above, characterized by the fact of using a preparation of the segmented type, due to the various working portions, point, cervical, intermediate, etc. The torque values applied are exactly suited to the portion which performs the work, and thus represent the optimum torque, which determines a more efficient sequence from the mechanical standpoint (mechanical yield).

4. BIOMECHANICAL ENDODONTIC PREPARATION SYSTEM pursuant to the appeals above, characterized by using an initial file called a pre-widening file, defining a depth limit, and the other files automatically cut only what is necessary to result in the desired canal conicity.

5. BIOMECHANICAL ENDODONTIC PREPARATION SYSTEM, pursuant to the appeals above, characterized by the fact that a given file has a cutting limit for a given region, and requiring the previous file to have also worked its region correctly.

6. BIOMECHANICAL ENDODONTIC PREPARATION SYSTEM, pursuant to appeal 1, characterized by the fact that the electro-electronic equipment has a source, control, sensor, torque sensor, analog/digital converter, compensation control, digital/analog converter, power control, direct/reverse selection, off/on control, control of motor 1 or 2, buzzer, display, keyboard, pedal, CPU.

7. BIOMECHANICAL ENDODONTIC PREPARATION SYSTEM, pursuant to the previous requests, characterized by the fact that the CPU is responsible for receiving all of the signals and commands and acting upon all of the output devices, as this interconnects the entire system and seeks the information of the configuration used last, adjusting work speed, turning on the motors and analyzing the torque values without load for subsequent calculations, after which it loads the data related to the sequence to be used and the torques that each file in the sequence will use.

8. BIOMECHANICAL ENDODONTIC PREPARATION SYSTEM, pursuant to the appeals above, characterized by the fact that the CPU monitors the keyboard and the pedal for the execution of the operator's commands, whereby the operator can select the working sequence, the motor system (single or double), a particular sequence, a change of sequence, placing the motor in reverse rotation and mode, adjust working velocity, turn the motors off and on, change over to the next file in the selected sequence, etc.

9. BIOMECHANICAL ENDODONTIC PREPARATION SYSTEM, according to the appeals above, characterized by the fact that the CPU monitors the operating torque of the motor and generates an audible signal which informs that it is reaching the maximum working torque of the file in use. And when the torque is exceeded, the CPU turns the motor off, places it in reverse mode so that the operator can remove the file, and returns it to normal mode to continue the process.

10. BIOMECHANICAL ENDODONTIC PREPARATION SYSTEM, pursuant to the appeals above, characterized by the fact that the CPU controls the motor velocity through an analog/digital converter, and if the compensation is internal, it calculates the value which is to be placed on the output in order to keep the motor at a constant speed, and also selects either motor 1 or 2 according to the next file to be used in the sequence.
